(19) United States
(12) Patent Application Publication
(10) Pub. No.: US 2010/0043981 A1
(43) Pub. Date: Feb. 25, 2010

(54) Method and device for producing receptacles coated with a film

(76) Inventor: Peter Steiner, Klagenfurt (AT)

Correspondence Address: FRIEDRICH KUEFFNER, 317 MADISON AVENUE, SUITE 910, NEW YORK, NY, 10017, US

(21) Appl. No.: 11/660,526

(22) PCT Filed: Aug. 5, 2005
(86) PCT No.: PCT/AT05/00314

§ 371 Date: Nov. 5, 2007

(30) Foreign Application Priority Data
Aug. 20, 2004 (AT) 1412/2004
Mar. 30, 2005 (AT) A 537/2005

(51) Int. Cl. B28B 19/00

(52) U.S. Cl. 156/390

(57) ABSTRACT

The invention relates to a method for producing receptacles coated with a film or label, particularly from EPS, EPP or EPE, during which the following steps are carried out: shaping the film or label (24) into a shape corresponding to the outer or lateral contour of the receptacle (11) to be produced; inserting the shaped film into a shaping tool (3, 5), and; back-filling the film (24) with the receptacle material. A device for producing a receptacle (11) of the aforementioned type comprises, in essence, a feed device for the film or label (24), and a shaping tool (3, 5). In addition, a receptacle is provided that is comprised of a film or label (24) in a shape corresponding to the outer or lateral contour of the receptacle (11), and is comprised of a receptacle material, which serves to back-fill the film or label (24) and which consists of, in particular, EPS, EPP or EPE.

The invention concerns a method for producing containers that are made of expanded (foamed) plastic, especially EPS, EPP, or EPE, and are coated with a film or covered with a label. The method comprises the following steps: filling the mold with foamed granules of container material by means of a stream of air and then fusing the granulated material by means of steam, where the granulated material may be fused at a pressure that differs from ambient pressure and/or at a temperature that is elevated above ambient temperature, where the pressure may be selected in a range of 0.5 bar to 8 bars and preferably either in a range of 0.5 bar to 1.5 bars or in a range of 5 bars to 6.5 bars, and where the temperature may be selected in a range of 80° C. to 150° C., preferably in a range of 90° C. to 145° C., and more preferably in a range of 110° C. to 130° C. (so-called in-line molding of EPS, EPP, or EPE). The invention also concerns a device for producing containers that are made of EPS, EPP, or EPE and are coated with a film or covered with a label. This device has a mold with a receiving part and a part to be received. In addition, the invention concerns a container produced in accordance with the invention.

So-called in-line molding is well known for expandable plastics and has proven itself effective. In this process, granulated material that has already been foamed (expanded) is introduced by a stream of air into the mold in the size and strength that are suitable for the given field of application and for the intended wall thickness. The air escapes through blow-off holes that are so small that they retain the granulated material. The granules of the granulated material are then densely fused with one another by heat and pressure, stabilized by cooling the mold, and then removed from the opened mold, for example, by a stream of air.

Containers of this type made of foamed plastic, such as in particular EPS, EPP, or EPE, are used, sometimes in very large numbers, for example, for holding foods and beverages, especially as drinking cups for hot and cold beverages or soups or the like. In general, cups of this type that are made from the aforementioned materials are not imprinted or labeled, since printing a plastic material of this type is possible only in a second process step with increased expense and limited graphic representation.

It may be assumed that containers of this type can be used, for example, for advertising purposes, but this would require suitably high-quality labeling or printing. However, this type of high-quality labeling or printing can be effectively achieved only with a film or label that covers or surrounds the container, which, for example, is made of EPS, EPP, or EPE. In this connection, containers of this type can already be produced with conventional methods and devices, and specially shaped films or labels can be applied to the containers in an additional, complicated, at least partly manual process step. However, an additional step for fastening the film or label on or with the container is necessary, for example, one involving adhesive bonding, so that once again it is difficult to realize economically practical production.

The objective of the present invention is to develop a method and a device of the aforementioned type, in which a container that is made of an expanded plastic, especially EPS, EPP, or EPE, and is directly coated or covered with a film or label can be produced by simple process steps.

In accordance with the invention, to achieve the objectives set forth above, the method defined at the beginning is characterized by the fact that the film or label is formed into a shape that corresponds to the outer contour or the lateral contour of the container to be produced; that it is inserted in the mold and properly positioned there by means of a suction device; and that the container material is then introduced into the space defined between the film and the mold.

After the film or label has been formed into a shape that corresponds to the outer contour or the lateral contour of the container to be produced, the shaped film or label is placed in a mold, and then the container material is backfilled against the film or label. During the backfilling, suitably secure joining takes place directly between the foil or label and the container material, so that intimate bonding between the film or label and the container occurs without it being necessary to provide an additional process step, especially one that involves adhesive bonding.

The production of the container by backfilling the film can be carried out by forming methods that are already well known for expanded plastics. Containers furnished with a film or label can thus be directly produced by simple process steps. A film or label of this type can then be immediately provided with high-quality printing or labeling, or the film or label can already be provided with high-quality printing or labeling before it is backfilled with the container material.

In the context of the present specification and the claims, the term “film” should be understood to mean generally any type of film or label or covering of a container made of the aforementioned plastics that can be backfilled with the container material.

In accordance with another preferred embodiment, to produce films or labels that can be labeled or printed suitably well, it is proposed that the film or label be made of plastic, especially polyethylene, polystyrene, polypropylene, PVC, films of biological material or paper, especially paper labels, or the like. Films and labels of these types can be produced at suitably low cost and in large numbers and have the material properties necessary for high-quality printing or labeling.

In accordance with another preferred embodiment, to provide further support of the method, especially with respect to the joining of the foil material and the container material, it is proposed that the film be heated during the introduction of the container material.

In accordance with another preferred embodiment of the method of the invention, as has already been noted, an essential criterion for economically practical use of a container produced by the method of the invention is that a printed or printable film or label be used.

In accordance with another preferred embodiment of the method of the invention, to realize especially simple production of the film or label, it is proposed that the film be formed into the shape that corresponds to the outer contour of the container to be produced by punching, cutting, processing by means of lasers, and the like.

In accordance with another preferred embodiment, to produce the desired material properties for the container, especially strength and temperature stability, it is proposed that the thickness of the container material be selected in the range of 0.5 mm to 60 mm and preferably either in the range of 1.5 mm (more preferably 2 mm) to 5 mm or in the range of 40 mm to 55 mm. The larger thicknesses are chosen especially for containers that are used, for example, for purposes of deep freezing or insulation.

Furthermore, to achieve the objectives that were set forth earlier, the device for producing containers coated or covered with a film or label, especially containers made of EPS, EPP, or EPE, comprises essentially the following elements:
a feeding device for a film or label, which has a shape that corresponds to the outer contour or the peripheral contour of the container to be produced, and
a mold with a receiving part and a part to be received, where the film can be inserted in the receiving part, and after the receiving part and the part to be received have been closed, the material for producing the container can be introduced, especially through the part to be received, into the space defined between the film and the part to be received.

Simple elements for the device of the invention are thus adequate for producing the containers in suitably large numbers and short cycle times with the device of the invention.

In accordance with another preferred embodiment, to ensure that the film or label to be backfilled is reliably held in the receiving part of the mold, a suction device is used to position the film in the receiving part of the mold.

In accordance with another preferred embodiment, to transfer the film properly into the mold, it is proposed that the feeding device for the film consist of a swivel arm for feeding the film into a position that can be swiveled with respect to the axis of the part of the mold to be received, such that a holder that is specially adapted to the shape of the film is provided for holding and guiding the film. The holder provided in accordance with a preferred embodiment for the purpose of holding and guiding the film ensures that the film, which possibly has a very small thickness and low strength, can be quickly and reliably inserted in the mold.

As mentioned above, a temperature that is elevated above ambient temperature and/or a pressure that is elevated above ambient pressure may be desirable for realizing proper and reliable joining between the film and the container material with which the film is to be backfilled. Therefore, in accordance with another preferred embodiment of the device of the invention, it is proposed that devices for applying increased pressure and/or increased temperature relative to ambient conditions be additionally provided, especially in the vicinity of the receiving part of the mold.

As in the case of fast and reliable insertion of the film in the mold, in order to remove the finished container quickly and reliably, it is proposed, in accordance with another preferred embodiment, that a device be provided, especially a swivel arm, for removing the finished container from the mold after the mold has been opened.

In accordance with another preferred embodiment, to realize the greatest possible automation of the insertion of the film or label in the mold and of the removal of the finished container from the mold, it is proposed that at least one conveyance device and/or one magazine be provided for feeding the film, especially to the swivel arm that feeds the film to the receiving mold part, and/or for removing the finished container.

Finally, to achieve the objectives that were set forth earlier, a container is made available, which consists of a film or label in a shape that conforms to the outer contour or the lateral contour of the container and a container material, especially EPS, EPP, or EPE, with which the film or label is backfilled.

A container of this type in accordance with the invention can be produced, for example, by the method specified above. In addition, the film or label of the container of the invention can be printed or labeled and preferably has the properties specified above.

The invention is explained in greater detail below with reference to the specific embodiments schematically illustrated in the accompanying drawings.

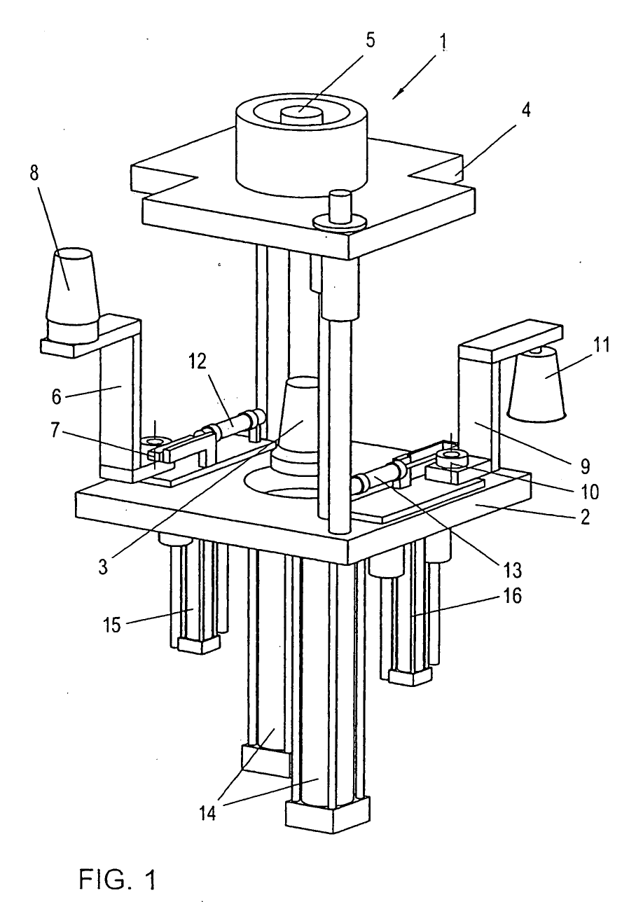

FIG. 1 is a schematic perspective view of a first embodiment of a device of the invention for carrying out the method of the invention for producing a container of the invention.

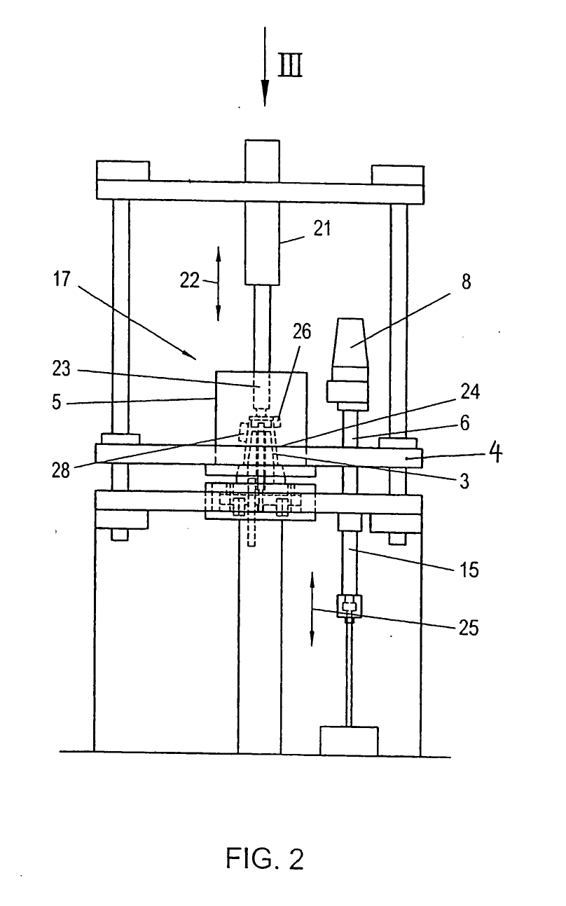

FIG. 2 is a schematic, partial side view that shows a slightly modified embodiment of a device of the invention in a phase of production of a container of the invention with the mold closed.

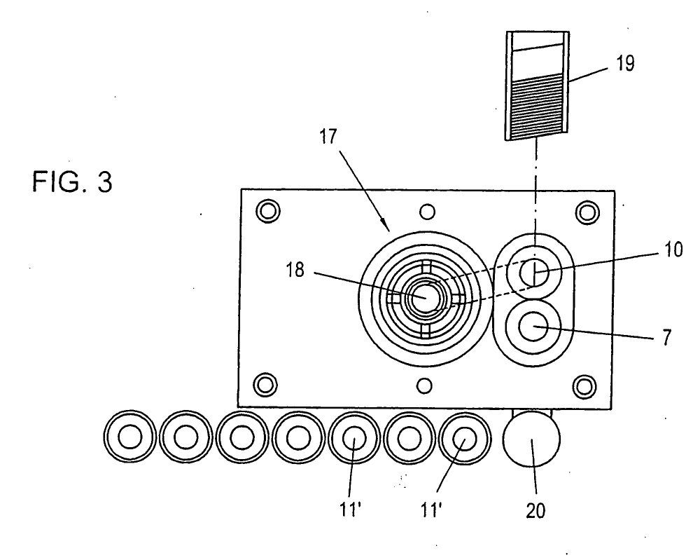

FIG. 3 is a partial top view according to arrow III in FIG. 2.

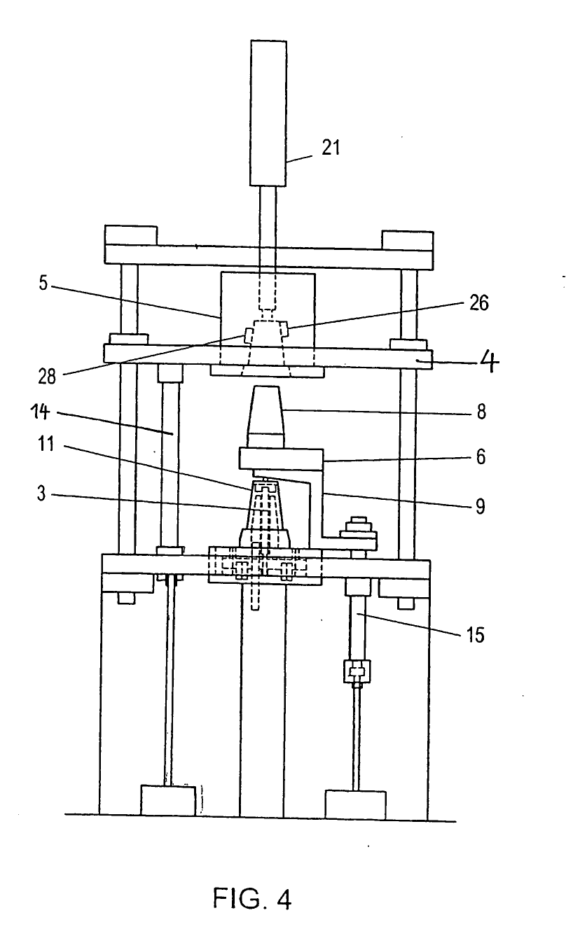

FIG. 4 is similar to FIG. 2 and shows a partial view of the second embodiment of the device of the invention with the mold in an open state after a container of the invention has been produced.

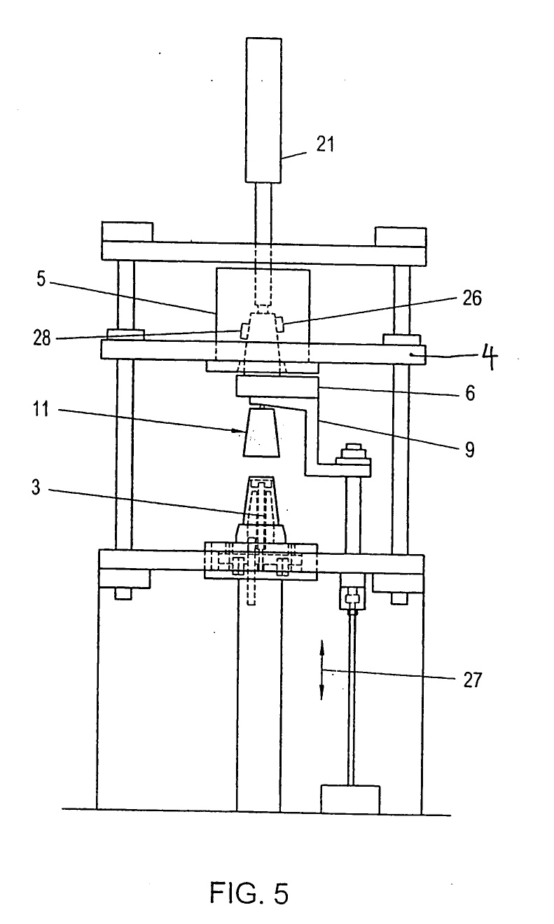

FIG. 5 is also similar to FIG. 2 and shows a schematic partial view of the second embodiment of the device of the invention in a phase of production in which a film or label is being inserted in the mold and a finished container of the invention is simultaneously being removed.

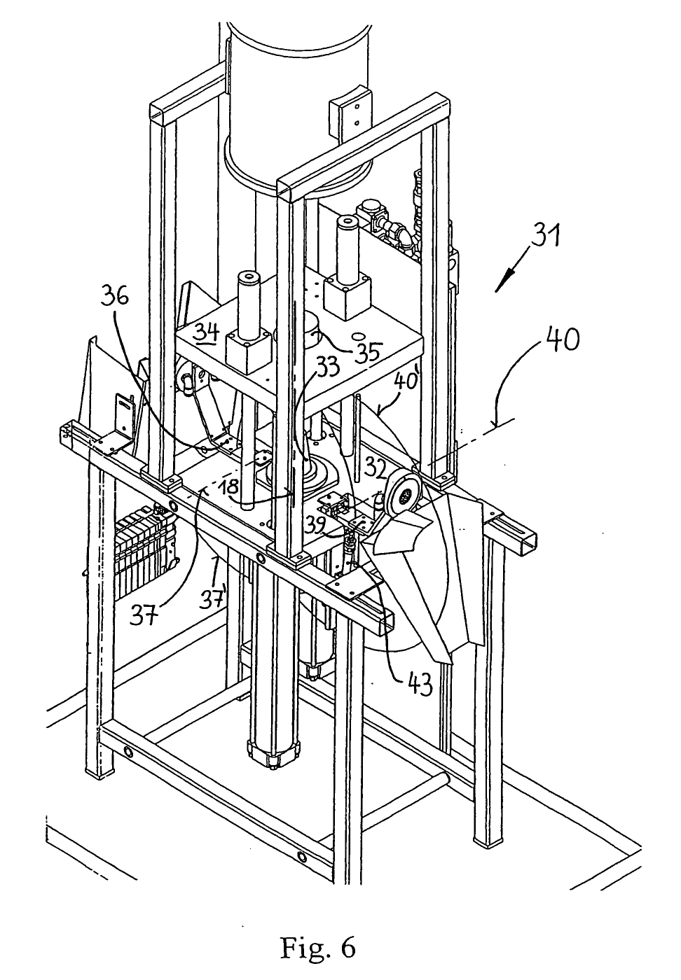

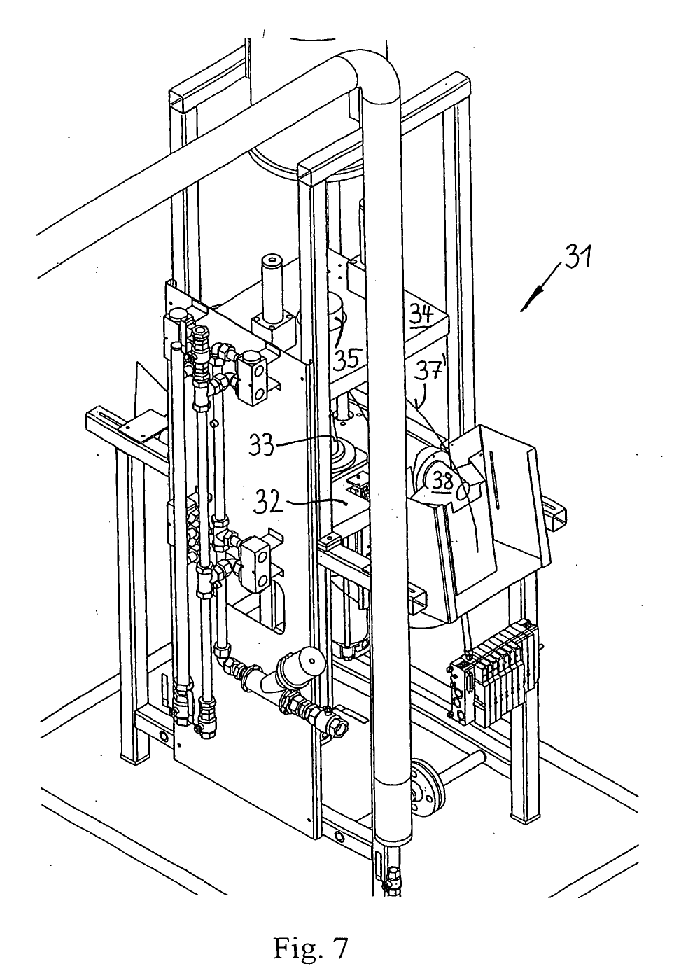

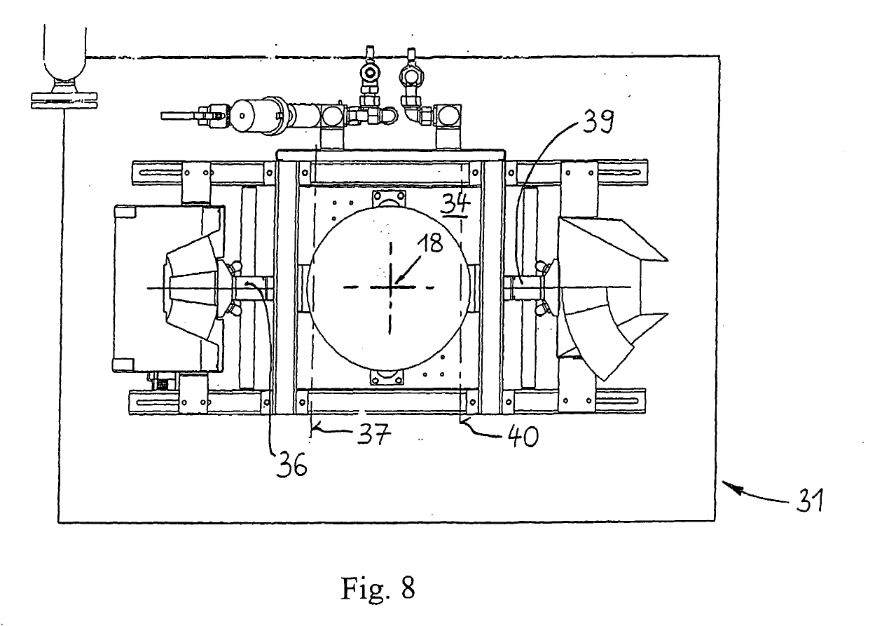

FIGS. 6 to 8 show three different views of a third embodiment of the invention.

FIG. 1 shows a first embodiment of a device 1 for producing a container, especially one made of EPS, EPP, or EPE, which is coated or covered with a film or label and is shown here in the open state. Individual features of this device 1 are discussed in detail with reference to some of the other drawings.

In FIG. 1, it is especially apparent that a part to be received or a male die 3 of a mold is supported on a holder or base plate 2. A receiving part or female die 5, which interacts with the male die 3, is supported on a holder 4, which can be raised and lowered relative to the base plate and is shown in detail especially in FIGS. 2, 4, and 5.

FIG. 1 also shows that a feeding device for inserting a film or label, especially a swivel arm 6, is held in such a way that it can rotate on the base plate 2 about a vertical axis 7, and a holder 8, especially a conical element that corresponds to the shape of the film or label to be inserted, is provided on the swivel arm 6. The swivel arm 6, with a film or label arranged on the holder 8, can be brought into a position defined by and aligned with the part to be received or male die 3 and the receiving part or female die 5, as will also be discussed in detail below.

FIG. 1 shows another swivel arm 9, which is used to remove a finished container. It can be rotated about a vertical axis 10. In the position illustrated in FIG. 1, a finished container 11 is shown held on the swivel arm 9. The swivel arm 9 can also be brought into a position of alignment with the parts 3 and 5, as will also be discussed in detail below. The swivel arm 9 can be raised and lowered, so that a finished container 11 can be removed from the male die 3 after production.

The swivel arms 6 and 9 are operated, for example, by piston-cylinder units 12 and 13, as illustrated in FIG. 1.

Other drives, for example, piston-cylinder units 14, are provided for adjusting the height of the holder 4 with respect to the receiving part 5 of the mold 3. In addition to drives for rotating the swivel arms 6 and 9 about their schematically illustrated axes of rotation 7 and 10, respectively, drives 15 and 16 are provided for raising and lowering the swivel arms 6 and 9, respectively.

The embodiment illustrated in FIGS. 2 to 5 differs from the embodiment illustrated in FIG. 1 essentially in that the axes of the swivel arms 6 and 9 are arranged on the same side of the mold, which is designated generally by reference number 17 in FIG. 3, rather than on diametrically opposite sides of the mold. For the sake of simplicity, the axes of the swivel arms are again designated 7 and 10. The central axis of the mold is designated 18 in FIG. 3. Moreover, as is schematically indicated in FIG. 3, the labels, which, for example, are shaped similarly to the lateral contour of the container to be produced and thus have no base, are taken from a magazine 19, while finished containers are removed to a discharge conveyor or again to a magazine 20. FIG. 3 shows several finished containers, which are identified by reference number 11′.

In the position shown in FIG. 2, it is apparent that the receiving part 5 of the mold is in the closed position and can be moved in the vertical direction by the holder 4. The filling injector 21 is used to fill the mold with the given foamed plastic that is to be used. It is permanently joined with the mold and moves up and down with the holder 4 in the vertical direction 22.

The film or label, which is indicated schematically in the receiving part with reference number 24, is visible in the male die part 3 and is backfilled with the container material through the mouthpiece 23 of the filling device/filling injector 21. In this connection, during the molding operation, not only is the film or label backfilled and the container material introduced, but also the container and the material of the film or label are directly joined at the same time. The film/label 24 is held in the receiving part 5 by means of a schematically indicated suction device 26.

If it is necessary to use a temperature that is greater than ambient temperatures and/or an elevated pressure for proper joining between the container material and the material of the film or label 24. Devices 28 designed for this purpose, for example, can be provided in the vicinity of the mold 17.

FIG. 2 further indicates that the swivel arm 6, which carries the holder or the opposing cone 8 for holding a film, can be raised and lowered by the piston-cylinder unit 15, as indicated by the double arrow 25.

After the production, as indicated in FIG. 2, of a container by backfilling of the film 24 inserted in the mold with the parts 3 and 5 of the mold closed, the part 5 of the mold is raised by the piston-cylinder unit 14 (FIG. 1), as shown in FIG. 4. At the same time, both the swivel arm 6 that carries the holder 8 and the swivel arm 9 are rotated to remove the finished container, which is again designated 11 in FIG. 4. After both swivel arms 6 and 9 have been brought into the vicinity of the central axis defined by the mold parts 3 and 5, both swivel arms 6 and 9 are raised relative to the mold parts 3 and 5 according to the double arrow 27, as indicated in FIG. 5, so that not only a new film is inserted in the receiving part 5 of the mold, but also a finished container 11 is lifted from the male die or mold part 3. After the swivel arms 6 and 9 have been rotated out of the area between the mold parts 3 and 5, the mold is closed again, so that a new container is produced by backfilling the film held in the receiving part 5 in the position shown in FIG. 2 after closure of the mold 17.

The individual phases of the production of a container 11 of this type can be summarized as follows:
forming the film or label 24 into a shape that corresponds to the outer contour or the lateral contour of the container 11 to be produced, for example, by punching, cutting, or laser processing;
inserting the film or label 24 in the receiving part 5 of the mold, as shown, for example, in FIGS. 4 and 5;
closing the mold 17, which consists, in particular, of parts 3 and 5, and backfilling the film 24, such that, to realize proper joining between the material of the film or label 24 and the container material with which the film or label 24 is to be backfilled, a pressure that differs from ambient conditions and especially an elevated temperature may be used; for example, when EPS is used as the container material, the pressure is selected in a range of 0.5 bar to 1.5 bars, and when EPP is used as the container material, for example, a pressure in the range of 5 bars to 6.5 bars is preferably used;
opening of the mold parts 3 and 5 after the production of the container 11 has been completed by backfilling and joining with the film (production cycle times of, for example, less than 10 s and preferably about 5-6 s can be realized);
moving a removal device, especially a swivel arm 9, into position to receive the finished container 11;
possibly moving a new film 24 into position at the same time to produce a new container;
removing the finished container 11.

As has already been noted, the film or label 24 can be shaped according to the lateral contour of the container 11 to be produced and thus without a base. In accordance with a variant of this embodiment, it is also possible to use a film or label 24 that conforms to essentially the entire outer contour of the container 11 to be produced.

The film 24 that is used can be a film or label that is already printed, or labeling, for example, advertising material, can be applied by suitable labeling or printing methods after the container 11 has been produced.

FIGS. 6 to 8 show a third embodiment of a device for carrying out the method of the invention. Where possible, the reference numbers of FIG. 1 are used to refer to corresponding parts, but the reference numbers here are prefixed by the numeral “3” in order to distinguish the two different embodiments. The device 31 likewise consists essentially of a base plate 32, on which a male die 33 of a mold is held. A female die 35, which interacts with the male die 33, is held on a holder 34 that can be raised and lowered relative to the base plate.

The feeding device for inserting a film or label consists of a swivel arm 36, which is held on the base plate 32 in such a way that it can rotate about a horizontal axis 37. The swiveling movement that the swivel arm 36 carries out with the film (or without a film) held on the holder 38 is indicated by the circle of rotation 37′, which is drawn beyond the actual range of motion.

To remove a finished container in this variant of the device, a swivel arm 39 is provided, which is joined with the base plate 32 in such a way that it can rotate about a horizontal axis 40 that is parallel to axis 37.

Piston-cylinder units 43 are provided to operate the two swivel arms 36, 39. The unit associated with swivel arm 36 is not visible in the view chosen here but rather is concealed by the table 32. The circle swept out by the free end of the swivel arm 39 is identified by 40′ in FIG. 6.

The selected, bent shape of the two swivel arms 36, 39 makes it possible, by simultaneously raising the holder 4 and swinging the empty swivel arm 39 into the raised female die 35, to release the container that has just been finished from the male die 3. At the same time as the swivel arm 39 is being swung back out, the swivel arm 36, which holds a film, is being swung in to insert a new film in the raised female die. The swivel arm 36 is now empty, while the swivel arm 39 holds a finished container, on which a quality-control inspection is carried out, preferably during the swiveling movement. The cups which are not defective are then conveyed further for stacking, while those which are defective are discarded. (If the swivel arms are suitably designed or if they are designed to be vertically displaced, to prevent them from colliding with each other along the axis, simultaneous swiveling in and swiveling out of the two arms would also be conceivable.) The descending female die 35 brings a film into the vicinity of the male die 33 in order to produce the next container after the device is closed. The holding device, preferably a suction device at the free end of the swivel arm 36, grabs the next film as the container is being produced in the closed mold, and the cycle begins again.

It is apparent that, compared to the device according to FIG. 1 as well as the device according to FIGS. 2 to 5, the sequence of movements is significantly simplified, and less space is needed, since it is not necessary both to rotate the swivel arms about vertical axes and to move them axially in the direction of the axis of rotation. Therefore, both the adjustment of the swivel arms with respect to the base plate 2 and the control of their movement relative to the other device are made simpler and less expensive. This cost reduction relates especially to capital investment, since the parts necessary for executing the swiveling motion are commercially available at low cost and with narrow tolerances, and a serial kinematic mechanism of the type that is necessary in the first two embodiments is completely avoided.

It is also significant that, due to the at least approximately parallel arrangement of the two axes of rotation 37, 40 in one plane each (or in a common plane), which is perpendicular to the axis 18 of the mold, it becomes possible to install a plurality of molds, together with their associated feeding devices and removal devices, in a small space and, advantageously, on a common holding plate and to drive them simultaneously with a common drive.

In this connection, instead of the pneumatic (rarely hydraulic) piston-cylinder units which have been described so far and which are exclusively used in prior-art devices, spindle drives with electric servomotors are preferably used here, since they also make it possible to move into intermediate positions simply and precisely. During a changeover of the installation to containers with a different height, this makes it possible simply to use a different program for controlling the servomotors instead of having to make a complicated changeover of the pneumatic piston-cylinder units.

The rotational motion of the arms is preferably effected by worm gears, which are usually self-locking and always have a high transmission ratio, so that even relatively weak electric motors can be used and transmissions are unnecessary, with the result that exact positioning is achieved in a simple way. The worm gears can act on toothed segments, which are nonrotatably connected with the arms, which results in a linear relationship between the turning of the worm gear and the rotation of the arm. Other possibilities, such as the extension of a lever or the like, do not result in linearity, but instead, when suitably designed, result in advantageous swiveling speed behavior.

Furthermore, these servomotors and worm gears make it possible to shorten the cycle times, since the swivel arms can already be set in motion before the mold is opened, which, for safety reasons, is not possible with pneumatic piston-cylinder units due to their uncertain speed-time behavior.

The use of hydraulic piston-cylinder units would be theoretically possible (incompressible medium) for intermediate positions but with low precision (thermal expansion of the fluid) and with the disadvantage of having to accept the risk of leakiness, which is strongly rejected by the customer, especially in the production of containers for holding foods, and necessitates special quality-control and leak testing.

The invention pertains only to the specific areas of the production process and device that have been described. The feeding of the shaped films or labels and the removal of the finished containers can be accomplished by various methods already known from the prior art and require no explanation here.

Vacuum transport is an especially advantageous method for delivering the films (understood to include all of the types and designs of films specified in this application and in the claims). In this connection, a stack of suitably shaped films is located in the vicinity of the “outer end position” of the swivel arm 36, and a hollow, U-shaped arm is lowered with its two ends on both sides over the swivel arm 36, which is in its outer end position, until the end regions of the arm come into contact with the uppermost film. Vacuum is then applied inside the arm, and this vacuum produces a temporary connection through holes in the area of contact between the U-shaped arm and the film. The arm is then lifted, the center part of the film comes into contact with the film holder, whose outer shape conforms to that of the container to be produced and which also has holes in its lateral surface which are under vacuum, so that the film is placed on this film holder and fixed in position on it, while the U-shaped arm leaves the swiveling range of the swivel arm 36.

The film holder is then brought into the area of the outer mold by swiveling the arm 36. The mold is lowered until it contacts the film, and vacuum is applied to holes in the mold, while a positive pressure is then built up in the film holder instead of the vacuum, so that the film is transferred from the film holder into the outer mold.

Finally, with vacuum or at least negative pressure still being applied in the outer mold, the (entire) mold is closed, the container is produced, and the mold is opened again. The finished container is released from the upper mold part by the application of positive pressure and conveyed away from the mold by the container removal arm. In the meantime, the film holder has picked up a new film, and thus the next cycle has already begun.

It is self-evident to an expert with knowledge of the invention that the shape and design of the swivel arms can be different from the illustrated embodiment. He can adapt this shape to the shape and dimensions of the container to be produced without any need for further special guidance and instruction. Finally, it is also unnecessary to attach the swivel arms directly on the base plate. It is only necessary that their axes of rotation run essentially parallel to the base plate and thus lie in a plane that is normal to the axis defined by the female die and the male die or their relative motion. Naturally, it is possible for the two axes 37 and 40 to lie in different planes normal to this mold axis. It is also unnecessary for these two axes to run parallel to each other, although in most cases it is advantageous for them to be parallel to each other to allow the best possible accessibility.

The drawings show fittings for the connection of pneumatic lines and vacuum lines at the swivel arms and in other places. These are intended solely for illustration. The same applies to the indicated suction devices and electric switch boxes.

Naturally, the illustrated embodiments can be combined in a wide variety of ways, provided only that the feeding device and the removal device do not collide with each other in the course of their movements or with the parts of the mold in the course of their movements. However, this does not present any problems to an expert in the field of automation who has knowledge of the invention.

1.-12. (canceled)

13. A device for manufacturing containers made of EPS, EPP or EPE and laminated with a film or coating the device comprising a mold with a mandrel and a part to be inserted, which parts may be movable relative to each other along a fixed mold axis, a feeding device for a film or coating having a shape to fit the size or outer contours of the container to be manufactured, for placing the film or coating in the mandrel, and a suction device for positioning the film or coating in the mandrel of the mold, feeding means for feeding the material for the container to be manufactured into the cavity defined between the film and the part to be inserted, wherein said feeding device for the film or coating is swivelable round a fixed swiveling axis.

14. The device according to claim 13, wherein the feeding means comprises means for feeding the material through the part of the mold to be inserted.

15. The device according to claim 13, wherein said feeding device for the film or coating is a first swiveling arm.

16. The device according to claim 13, wherein said feeding device for the film or coating comprises a moving arm for feeding the film or coating in a position flush with the fixed mold axis of the mold part to be inserted, and wherein on said swiveling arm is mounted a holder adapted to the shape of the film or coating for taking and guiding the film or coating.

17. The device according to claim 13, wherein a removing device, is used for removing the completed container from the mold after opening the mold and wherein said removing device is swivelable round a fixed swiveling axis.

18. The device according to claim 17, wherein the removing device is a second swiveling arm.

19. The device according to claim 13, wherein the drives for swiveling the feeding device and/or the removing device are linear drives.

20. The device according to claim 19, wherein the drives for swiveling the feeding device and/or the removing device act on said devices in a distance from said swiveling axes.

21. The device according to claim 17, wherein said swiveling axis of the feeding device and said swiveling axis of the removing device are positioned parallel to each other.

22. The device according to claim 21, wherein said swiveling axis of the feeding device and said swiveling axis of the removing device define a plane which is positioned perpendicular to the fixed mold axis.
